(19) United States
(12) Patent Application Publication
(10) Pub. No.: US 2009/0037301 A1
(43) Pub. Date: Feb. 5, 2009

(54) INVENTORY MANAGEMENT SYSTEM WITH TIME FEATURE

(75) Inventor: Allan Powell, Powell, OH (US)

Correspondence Address: Law Office of Scott C Harris Inc, PO Box 1389, Rancho Santa Fe, CA, 92067, US

(73) Assignee: Production Resource Group L.L.C., New Windsor, NY (US)

(21) Appl. No.: 12/123,444

(22) Filed: May 19, 2008

Related U.S. Application Data
(60) Provisional application No. 60/939,587, filed on May 22, 2007.

(51) Int. Cl. G06Q 10/00

(52) U.S. Cl. 705/28

(57) ABSTRACT

An inventory system which stores information indicative of a time until the inventory will be ready for reuse. The inventory system may automatically estimate that time based on information. The information can include a time of testing, a time until testing can be carried out, and/or a repair time.

This application claims priority from Provisional application No. 60/939,587, filed May 22, 2007, the disclosure of which is herewith incorporated by reference.

### BACKGROUND

Equipment for shows is typically rented so that the show can easily get the equipment, return it to the rental company, and then either move the show to another location or shut down completely. Successful rental companies must have certain kinds of equipment available for rental to the customers. It is also important that the rental company know what they have on hand, and how quickly they can rent it. Sometimes rentals are short-term rentals, other times they are long-term rentals.

When the equipment is returned, it needs to be examined to make sure it is ready for re-rental.

### SUMMARY

The present application teaches an inventory management system adapted for use with show equipment. More specifically, the inventory management system may be adapted for use with units there are intended for rental as part of the show, for example cable, moving lights, and other equipment. More specifically, the inventory management system is adapted for use in a situation where products are rented out, taken back in, and repaired.

### BRIEF DESCRIPTION OF THE DRAWINGS

FIG. 1 shows an overall diagram; and

FIG. 2 shows a flowchart of operation.

### DETAILED DESCRIPTION

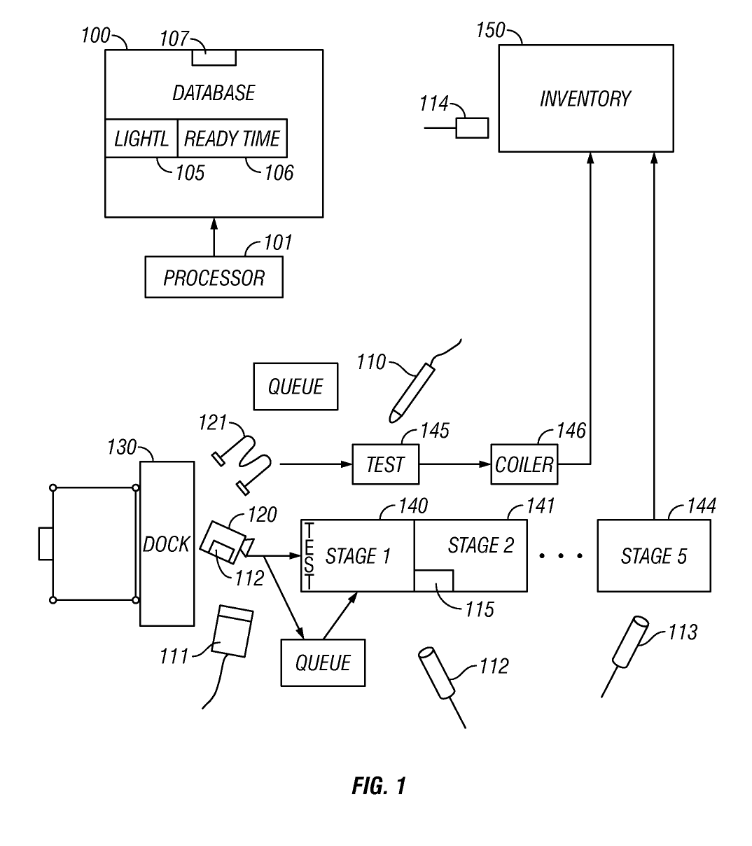

FIG. 1 illustrates an embodiment. The basic structure includes a database 100 that stores at least one file indicating the items that are in inventory, as well as their readiness for rental. A processor 101 is used to execute the flowcharts described herein and maintain housekeeping functions. In the embodiment, 105 shows a record indicating light 1. 106 shows a record for a ready time, indicating the time until the light 1 is likely to be ready for rental.

A number of scanners 110 are provided. Each scanner such as 110-114 may scan a corresponding sticker or readable item 112 on a corresponding piece of equipment 120. For example, the moving light 120 may include a barcode sticker 112 that includes a unique serial number or other designation indicating the light. That number may be looked up in the database, which may also include a conversion file 107 that indicates the unique serial number and the kind of light or equipment that corresponds to that unique serial number. Each scanner 110, 111, 112, 113, 114, as well as other scanners, are aware of their position in the chain. For example, the scanner may be permanently assigned at a specific location. Alternatively, different areas may have different location codes such as a POI location code 115 that represents the position of stage 2 of a five-stage tester.

In operation, the equipment is first unloaded from a truck, onto loading dock 130. Loading dock 130 may be considered as the entry to the inventory system. Each specific piece of equipment needs to go through specified tests before it can be returned to inventory 150. For example, the moving light 120 may have a multistage test that it needs to go through. The cable 121 may also have a test sequence, defining the different steps of the test sequence requiring a different number of stages.

In addition, when many different devices are brought in, each of them needs to be tested. Therefore, there is also a queue. For example, if five lights are brought in, the first light may be started on testing, while the second through fifth lights are queued for the testing. Of course, if there are multiple test sections, mere lights may be tested at once, with fewer lights being correspondingly added to the queue.

When a light such as 120 is scanned, its position is detected, as well as the number of lights in the queue ahead of it. Each light such as 120 requires a specified test time. Moreover, as the light progresses to different stages, the test time may change. For example, when the light first comes off the truck on the loading dock 130, its expected test time may be five hours, adding 15 minutes for each light ahead of it in the queue. However, when the light gets to stage 1 of the test, shown as 140, it is scanned there. At that time, the expected time until ready may be four hours. At stage 2, 141, the expected time to ready may be three hours, and at stage five shown as 144, the expected time to ready may be one hour. After the light is fully tested, it is sent to inventory 150. Any light in inventory has a ready time of zero—meaning it is completely ready to rent.

According to an embodiment, the queue time may also include shift information. For example, if an item comes in at 3:45, and the testing shift ends at four o'clock, the time until testing might not start again until the next morning at 8 a.m. The total time until ready may also take into account the shifts of people who do the test.

The cable may have an entirely different test sequence. The cable test is shown as simply test the cable (for continuity or other tests as described in our copending application Ser. No. 11/940,263, filed Nov. 14, 2007) for example, at 145, of followed by coiling the cable at 146. This may be a total test time of 45 minutes.

Therefore, when the cable 121 is first put on the dock, the time to rental may be considered as one hour plus 10 minutes for each item in the queue. Similarly, different pieces of equipment may have different test sequences and different associated times. Some lights may require more testing than others.

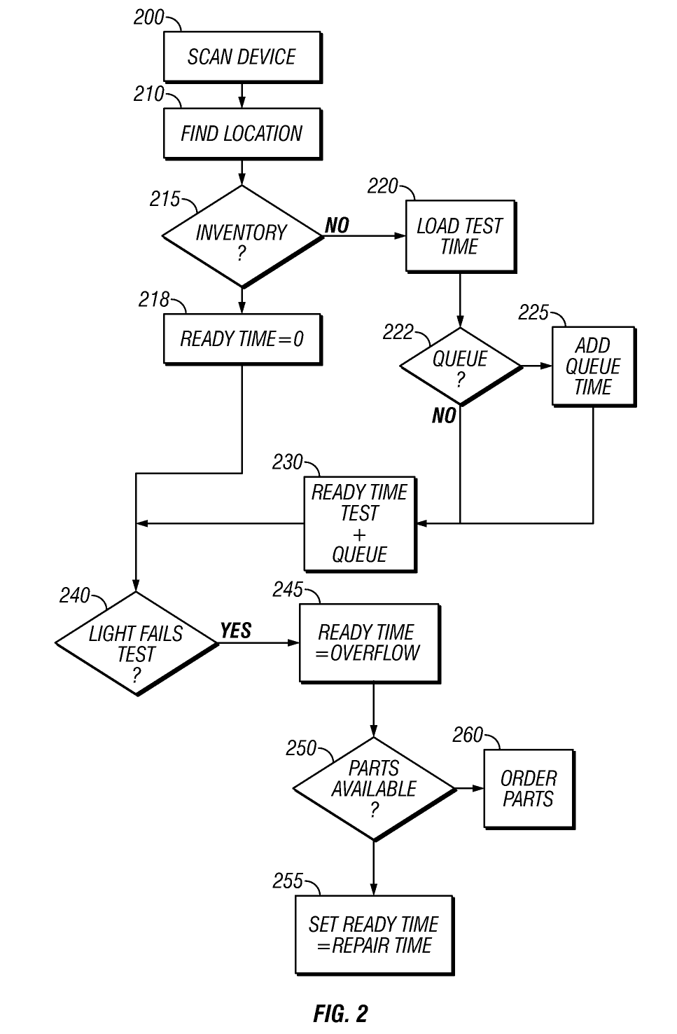

The operation follows the flowchart of FIG. 2. At 200, the device is scanned, and at 210, the location of the scan is ascertained. For example, the location of the scan

may be obtained by scanning a position marker such as 115, or from the designation of the scanner which may be permanently associated with a specific location.

215 determines if the location of the device is in inventory 150, and if so, the ready time is set to zero, indicating that the equipment is now ready for rental. If the location is anything other than inventory, a test time is loaded at 220 based on location. For example, for each of the positions of the equipment, the loading dock 130, stage one 140, stage 2, 141, or test 145, or any other location for any specific equipment, there is an associated time to ready. That time to ready is loaded at 220 based on the light's current position. At 222, a system determines whether other similar devices are ahead of the current device in the queue. If so, a queue time is added at 225. The ready time is finally determined at 230 as being the test time plus the queue time. Testing continues, until the device either makes it to inventory, or fails a test at 240. When a light fails the test, the ready time is first set to overflow, e.g. the maximum ready time that is possible. 250 can use the inventory management system to determine if the parts are available based on the specific way in which the device has failed the test. If the parts are available at 250, an estimated repair time is taken from the database, and the ready time is set to be that estimated repair time for this kind of equipment to be repaired in this specific way. If not, parts are ordered at 260, and the ready time can either be left as the overflow, or can be set to an estimated time of arrival of the parts, added to the repair time.

Although only a few embodiments have been disclosed in detail above, other embodiments are possible and the inventors intends these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, while the above has described certain variables and handling o those variables, others are alternatively possible.

Also, the inventor intends that only those claims which use the words “means for” are intended to be interpreted under 35 USC 112, sixth paragraph. Moreover, no limitations from the specification are intended to be read into any claims, unless those limitations are expressly included in the claims.

This system can be used in the light of the type shown in FIG. 1 which can be controlled by a remote console, that communicates with the light over wired or wireless protocols such as DMX 512. Both the console and the light can include computers therein. The computers described herein may be any kind of computer, either general purpose, or some specific purpose computer such as a workstation. The computer may be an Intel (e.g., Pentium Core 2 duo) or AMD based computer, running Windows XP or Linux, or may be a Macintosh computer. The computer may also be a handheld computer, such as a PDA, cellphone, or laptop.

The programs may be written in C or python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network attached Storage (NAS), or other removable medium.

The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. An inventory management system, comprising:
a computer that determines a first record that stores information indicative of a product in inventory and stores said first record, determines a second record that stores information indicative of a nonzero time until said product will be ready for distribution to customers.

2. A system as in claim 1, wherein said determines said second record comprises determining an estimated time until a broken product will be repaired.

3. A system as in claim 1, wherein said determines said second record comprises determining an estimated time until a product will be tested.

4. A system as in claim 3, wherein said determines said second record comprises using the computer to estimate the time based on a total time of testing of a specific product, where a first total time of testing is different than a second total time of testing.

5. A method, comprising:
obtaining information of incoming inventory materials, wherein said information includes a designation indicative of a specific item;
estimating a time until said item will be completed with testing, said estimating comprises estimating a time of total testing, and also a queue before which said testing will be carried out; and
storing information indicative of said inventory materials, including at least a first record that indicates a first item which is ready for distribution to customers, and a second item that is not ready for distribution to customers, where said second item also includes an indication of an estimated time until said second item will be ready for distribution to customers.

6. A method as in claim 5, wherein said obtaining information comprises determining, from said designation, a class of said item, where said in said class can be one of a number of different classes, and based on said class, determining said time of total testing.

7. A method as in claim 6, wherein said time of total testing for a first class is different than a time of total testing for a second class.

8. A method as in claim 7, wherein one of said classes is a lighting device, and another of said classes is a cable for a lighting device.

9. A method as in claim 7, further comprising determining from said class, a number of items in said class which are in a queue to be tested ahead of a current item.

10. A method as in claim 5, wherein said time of total testing comprises a multiple stage test, and said time of total testing comprising a combination of times for testing of all stages.

11. A method as in claim 5, further comprising determining an item which needs repair, estimating a total time for said repair, and wherein said time to ready includes said total time to repair.

12. A method as in claim 11, wherein said estimating the total time for said repair comprises determining if parts are in stock, and setting a first time to repair if the parts are in stock, and setting a second time to repair longer than said first time to repair if the parts need to be ordered.

13. A method, comprising:
receiving an item into inventory that has been used;
automatically estimating a time until said item can be resent to a different user; and
storing information indicative of said item and information indicative of said time into a database.

14. A method as in claim 13, wherein said information indicative of said time is a time until testing will be complete.

15. A method as in claim 13, wherein said information indicative of said time is a time until repair will be complete.

16. A method as in claim 15, wherein said time until repair will be complete comprises an estimation of time until parts will be available.

17. A method as in claim 14, wherein said estimating comprises determining a specific item, and determining a total test time for said specific item.

18. A method as in claim 17, wherein said total test time for said specific item is different for a first specific item than it is for a second specific item.

19. A method as in claim 18, wherein said estimating further comprises determining a queue time until said specific item will be tested.
